(19) United States
(12) Patent Application Publication
(10) Pub. No.: US 2022/0347929 A1
(43) Pub. Date: Nov. 3, 2022

(54) SYSTEM AND METHOD OF USING FEEDBACK FOR CORRECTING THREE DIMENSIONAL OBJECTS IN VOLUMETRIC TOMOGRAPHIC PRINTERS

(71) Applicant: ECOLE POLYTECHNIQUE FEDERALE DE LAUSANNE, Lausanne (CH)

(72) Inventors: Paul Delrot, Morges (CH); Damien Loterie, Ecublens (CH); Christophe Moser, Lausanne (CH)

(73) Assignee: ECOLE POLYTECHNIQUE FEDERALE DE LAUSANNE, Lausanne (CH)

(21) Appl. No.: 17/621,133

(22) PCT Filed: May 25, 2020
(86) PCT No.: PCT/EP2020/064405

§ 371 Date: Dec. 20, 2021

(30) Foreign Application Priority Data
Jun. 21, 2019 (EP) 19181595.0

(51) Int. Cl. B29C 64/393; B33Y 10/00; B33Y 30/00; B33Y 50/02; B29C 64/129; B29C 64/277; G06T 7/00

(52) U.S. Cl. CPC B29C 64/393; B33Y 10/00; B33Y 30/00; B33Y 50/02; B29C 64/129; B29C 64/277; G06T 7/001; G06T 2207/20224; G06T 2207/30108

(57) ABSTRACT

The invention discloses a system and method to obtain a set of corrected projected patterns from an integrated 3D measurement system so that the solidification of the formed object appears at the same time in a volumetric printer such as a tomographic back-projection or multi-beam printer, hence ensuring that the object is formed with the highest fidelity and spatial resolution.

### BACKGROUND OF THE INVENTION

### 1. Field of the Invention

The present invention relates to a system and method to improve the quality such as the resolution and fidelity of a 3D object in volumetric tomographic printers for the volumetric fabrication of three-dimensional objects or articles from photoresponsive materials, by use of a measurement of the 3D object in-situ followed by a corrective action, which is a significant improvement over prior art. In particular, the present invention is refated to volumetric manufacturing systems wherein the articles or objects being fabricated are imaged and monitored in real-time.

### 2. Background Art

The working principle of volumetric tomographic printing (WO 2019/043529 A1) is entirely different than the traditional layer-by-layer approach (i.e. 3D printing with the formation of one layer over the other) in conventional additive manufacturing (AM).

In conventional additive manufacturing, a three-dimensional object is fabricated either by pointwise scanning of the object volume or in a layer-by-layer fashion. An example is stereolithography (SLA) (see for example U.S. Pat. No. 5,344,298), where the object is formed one layer at a time by the solidification of a photocurable resist under light irradiation before application of a subsequent layer. The successive layers of the object can be defined for example by scanning a laser beam point-by-point, as suggested in U.S. Pat. No. 5,344,29, or by digital light processing (DLP) technology, as described in U.S. Pat. No. 6,500,378.

In these methods, the photopolymerization process of the successive object's layers is controlled by using highly absorbing and strongly reactive resins. The layer thickness typically ranges from 10 μm to 200 μm. To cure well-defined layers of resins, a large concentration of one or more photoinitiators and dyes are typically included in resins so that they are highly absorbing and strongly reactive (T. Baldacchini, Three-Dimensional Microfabrication Using Two-Photon Polymerization, William Andrew, 2015). Thus, using highly absorbing inks is beneficial in SLA and DLP as it prevents the exposure of an already processed layer by the next layer being formed, which could result in manufacturing artefacts, a phenomenon referred as overcuring in additive manufacturing.

To overcome the geometric constraints and throughput limitations of layer-by-layer light-based AM techniques, namely digital-light processing (DLP) and stereolithography (SLA), multi-beam AM techniques have been proposed (Shusteff, M. et al., One-step volumetric additive manufacturing of complex polymer structures, Sci Adv 3, eaao5496- (2017); Kelly, B. E. et al., Volumetric additive manufacturing via tomographic reconstruction, Science 363, 1075-1079 (2019); Loterie, D., Delrot, P. & Moser, C., VOLUMETRIC 3D PRINTING OF ELASTOMERS BY TOMOGRAPHIC BACK-PROJECTION (2018), preprint DOI: 10.13140/RG.2.2.20027.46889). These techniques are subsequently referred to as volumetric tomographic printing or tomography-based additive manufacturing (tomographic additive manufacturing).

In tomography-based additive manufacturing methods, the object is not formed by sequentially curing layers of a photopolymer, but rather a volume of transparent photoresponsive material is irradiated from multiple angles with computed patterns of light, which results in the local accumulation of light dose and the consequent simultaneous solidification of specific object voxels, in order to fabricate a three-dimensional object in a single step. The main advantages of this method compared to existing methods are its very rapid manufacturing time (down to a few tens of seconds), and its ability to print complex hollow structures without the need for support structures as required in layer-by-layer manufacturing systems.

To achieve a correct three-dimensional light dose deposition in the build volume, the two-dimensional light patterns projected from multiple angles must illuminate the entire build volume. Thus, resins with a low-absorptivity at the illumination wavelength are used. Typically, a correct light dose deposition is achieved in tomographic additive manufacturing methods with an attenuation length of the illuminating light at 1/e equal to the diameter of the build volume, which sets an upper limit on the photo-initiator concentration.

Though such volumetric part generation allows processing more viscous resins than in existing DLP and SLA techniques (>4 Pa·s) that yields higher throughput (>105 mm3/hour), the smallest feature size demonstrated by multi-beam AM is currently limited to approximately 300 μm.

As opposed to DLP and SLA, where the polymerization extent of a layer is controlled by using highly absorbing resins, volumetric AM requires transparent resins which results in a reduced spatial and temporal control of the photopolymerization process and consequently limits the achievable printing resolution.

Therefore, the tomographic photopolymerization process has to be monitored to achieve high-resolution manufacturing of objects or articles.

As a consequence, there is a need for a robust, industrially applicable method and system to image and monitor the articles or objects being fabricated in cylindrical build volumes of various diameters via tomography-based additive manufacturing.

### SUMMARY OF THE INVENTION

The present invention circumvents all of the previous shortcomings of 3D objects printed with a volumetric approach such as with tomographic back-projection.

The invention herein disclosed provides higher resolution. Experimental demonstration showed a resolution of 80 μm with volumetric production of centimeter-scale acrylic and silicone parts by feedback-enhanced tomographic reconstruction.

In detail, the present invention is related to a method for monitoring the generation of a three-dimensional object being formed in a tomographic additive manufacturing system from simulated tomographic two-dimensional back-projections of a desired 3D article, the method comprising the steps of:
illuminating a container comprising a photoresponsive material with a light beam of two-dimensional light patterns generated from said two-dimensional back-projections at multiple angles, preferably by rotation of the container, so as to form the object in the container;
capturing images of said object being formed by volumetric printing with an imaging system disposed around the container in which the object is being formed;
determining from said images the shape or extent to which the object has been formed, preferably by computerized object recognition;
based on the determination, either
   i. generate a new set of two-dimensional light patterns for tomographic printing;
   ii. correct in real-time the two-dimensional light patterns used for tomographic printing;
   iii. extend said tomographic additive manufacturing process; or
   iv. stop said tomographic additive manufacturing process, thereby finishing the formation of said object (5)

Preferably, the variants i) to iv) are carried out automatically.

According to a preferred embodiment, the present invention is related to a method for obtaining a set of corrected projection patterns in a volumetric back-projection printer, the method comprising the steps of:
Measuring two-dimensional projections of an object being formed by volumetric printing with an imaging system disposed around a container in which the object is being formed;
Forming a three-dimensional image from said two dimensional measured projections;
Extracting a difference between the desired 3D object and the object measured with the imaging system;
Generating a new set of projection patterns by reverse tomographic back-projection.

Preferably, two-dimensional projections of said desired 3D article are computed from an original 3D digital object, more preferably a 3D CAD object.

Preferably, the images of said object are captured by said imaging system concurrently with illuminating said container with the two-dimensional light patterns.

Preferably, the method further comprises the step of capturing reference background images at multiple angles of the container comprising the photoresponsive material, preferably by rotation of the container, before said container is illuminated with the two-dimensional light patterns, wherein in the step of determining from said images the shape or extent to which the object has been formed the reference background images are subtracted from the captured images of said object being formed, so as to detect parts of the resin container that became polymerized using a threshold. In particular, from such detected polymerized parts a 3D map is created by a tomographic back-projection method, and new set of projection patterns is generated by comparing the created 3D map with the original 3D digital object, preferably 3D CAD object, wherein the new set of projection patterns is used either for printing the same object (5) by restarting the method, using the first printed object (5) as a sacrificial print, or for implementing a real-time correction feedback system.

Preferably, from detected polymerized parts a map of the regions of the object is generated that have already been formed as seen from the angles at which each captured image and optionally background image was recorded, and
the method is stopped if it is detected that all parts of the object (5) have been formed, or
the method is continued without modification of the two-dimensional light patterns if it is detected that no part of the object (5) has been formed, or
the two-dimensional light projections used for tomographic printing are corrected in real-time such that corresponding regions at the corresponding angles are disabled or attenuated in the two-dimensional projections of light used to form the object.

Preferably, the imaging system comprises a structured illumination for generating the captured images. In particular, a difference is extracted between the captured images of the object being formed and the desired 3D article, said difference being used to generate the new set of projection patterns by reverse tomographic back-projection. Especially preferred, said extracted difference is used for determining whether the object has been completely manufactured or whether the shape of the object is correct, wherein the method is stopped if complete manufacturing of the object is determined, or illuminating the container with two-dimensional light patterns continues if the shape of the object is correct or no complete manufacturing of the article is determined. According to another preferred variant of this embodiment comprising structured illumination, each of said measurements of the two-dimensional projections of the object is obtained by performing a differential overlay of a first two-dimensional projection measured with said imaging system at an angle by a second two-dimensional projection previously measured with said imaging system from said same angle.

Preferably, the beam is modulated by projection patterns in a DLP modulator.

Also preferably, the beam and either the structured illumination or a measuring beam enter the container at an angle of 90°.

The present invention is furthermore related to a method of printing an object in a volumetric back-projection printer, the method comprising the steps of
Obtaining a set of corrected projection patterns with the above method;
Printing the object using the set of corrected projection patterns.

The present invention is in addition related to a method of imaging an object in a volumetric back-projection printer for monitoring the production process of a three-dimensional article.

The present invention is furthermore related to a system for performing the method of the present invention defined above, comprising
A resin container for providing a photoresponsive material to be polymerized, wherein said resin container is rotatable;
A unit for providing a light beam of two-dimensional light patterns to be guided into the resin container, said unit comprising a DLP modulator and preferably at least one lens;
An imaging system disposed around the resin container, wherein said imaging system comprises either a) a measuring beam, a camera and a lens system, or b) a display unit emitting a structured light pattern, a lens system, an optional optical filter, and a camera sensor; and
A processing unit for determining from images captured by the imaging system a shape or extent to which an object has been formed when performing the method of the present invention.

Preferably, said display unit comprises a component selected from the group consisting of a liquid-crystal display illuminated by light with one or more colors, an organic light-emitting diode display with one or more colors, and a light-emitting diode display.

Preferably, said resin container (is arranged in an index matching liquid bath.

Preferably, said imaging system and said unit for providing a light beam to be guided into the resin container are arranged such that an angle, preferably of 90°, is formed between the beam or the structured illumination and the beam when entering the resin container.

### BRIEF DESCRIPTION OF THE DRAWINGS

These and other features, aspects and advantages of the present invention will become better understood with regard to the following non-limiting description, appended claims and accompanying drawings where:

FIG. 1: is a schematic illustration of a first embodiment of the volumetric tomographic printer and the three-dimensional imaging system according to the present invention.

FIG. 2: is a schematic illustration of the process flow for the first embodiment of the three-dimensional measurement of the resin solidification and the correction of the projection patterns according to the present invention.

FIG. 3: shows examples of objects printed without feedback and with the feedback mechanism according to the first embodiment of the present invention.

FIG. 4: is a schematic illustration of one alternative of the first embodiment of the process flow for using the corrected pattern for subsequent 3D prints according to the present invention.

FIG. 5: is a schematic illustration of another alternative of the first embodiment of the process flow for using the corrected patterns in real time during the fabrication of the object according to the present invention.

FIG. 6: is a perspective view of a second embodiment of the present invention, in which a structured illumination allows imaging a three-dimensional article being produced with a tomographic additive manufacturing apparatus.

FIG. 7: is an experimental structured-illumination imaging of tomographic additive manufacturing performed with an apparatus similar to the one illustrated in FIG. 6.

FIG. 8: is a flowchart describing a method according to the second embodiment of the present invention to increase the structured-illumination imaging sensitivity.

FIG. 9: is an experimental structured-illumination imaging of tomographic additive manufacturing performed with a differential overlay method to increase the imaging sensitivity according to the second embodiment of the present invention.

FIG. 10: is a flowchart describing a method according to the second embodiment of the present invention to automatically stop the tomographic additive manufacturing process using the structured-illumination imaging.

FIG. 11: is a flowchart describing a method according to the second embodiment of the present invention to correct the two-dimensional light patterns of the tomographic additive manufacturing process using the structured-illumination imaging.

FIG. 12: is a flowchart describing a method according to another variant of the second embodiment of the present invention to correct the two-dimensional light patterns of the tomographic additive manufacturing process using the structured-illumination imaging.

FIG. 13: is a flowchart describing a method according to the third embodiment of the present invention to correct the two-dimensional light patterns of the tomographic additive manufacturing process using the structured-illumination imaging.

### DETAILED DESCRIPTION

The present invention is related to volumetric tomographic manufacturing systems wherein the articles or objects being fabricated are imaged and monitored, preferably in real-time. In tomographic additive manufacturing, monitoring the photopolymerization process leading to the formation of a three-dimensional article is critical for obtaining a high geometric fidelity with respect to its digital three-dimensional model and to adapting to different resins' reactivity. The present invention discloses an apparatus and methods to monitor tomographic additive manufacturing of three-dimensional articles, preferably with a structured illumination.

Volumetric back-projection printing, including the method of obtaining simulated tomographic two-dimensional back-projections of a desired 3D article and generating two-dimensional light patterns from said two-dimensional back-projections, and respective printer suitable for said printing technique have been described in e.g. WO 2019/043529 A1 or US 2018/0326666 A1. In tomographic volumetric additive manufacturing, a volume of photoresponsive material is illuminated from many directions with patterns of light. These patterns of light are computed with an algorithm similar to that used in X-ray computed tomography, also known as medical CT scanners. These algorithms are known to the skilled person.

The tomographic approach delivers a 3D light dose in such a way that when an individual voxel obtains enough dose, it turns from liquid to solid. This individual voxel immediately scatters light because of the refractive index difference between the solid and the surrounding liquid. To avoid light scattering, all 3D voxels must transition from liquid to solid at the same time. The requirement that all 3D voxel forming the object must obtain the same light dose instantaneously is quintessential to the accurate formation of the 3D object.

Optical beam non-uniformity, resin non-uniformity, vial non-uniformity, as well as the increase of chemical reaction kinetics that are dependent on local temperature because of the exothermic polymerization reaction, makes the system intractable in an open loop configuration to obtain the highest resolution and fidelity of the 3D printed object. Because of these reasons, a feedback system is not a “nice to have” feature, but a “must have” for tomographic printing.

Monitoring and thus detecting the fabrication of the tomographically-produced objects allows, for instance, to automatically stop the exposure of the build volume, if the resin being used has a different reactivity than resins known to the operator. In addition, monitoring and detecting the fabrication of the tomographically-produced objects allows to automatically stop the exposure of the build volume, if an object is formed faster or more slowly than theoretically expected. Furthermore, monitoring the fabrication of the tomographically-produced objects allows to measure the geometric fidelity of the formed object to the digital model and therefore to adjust the light patterns illuminating the build volume, either in real-time or from one print to another.

Imaging transparent objects being polymerized in a transparent photoresponsive liquid or gel may be achieved by measuring a small refractive index change between the solid phase of the object and the liquid or gel phase of the unreacted photoresponsive material over a centimeter-scale volume. This refractive index change between the monomer and polymer form of the resin is typically 0.01 to 0.05 for acrylic resins (Refractive index of methacrylate monomers & polymers. Technical bulletin [online]. Esstech Inc., 2010 [retrieved on 2020 Mar. 19]. Retrieved from https://www.esstechinc.com/refractive-index-of-methacrylate-monomers-polymers/).

According to the present invention, it was found that measuring a refractive index change between the solid phase of the object and the liquid or gel phase of the unreacted photoresponsive material can be used for establishing a robust, industrially applicable method and system to image and monitor the articles or objects being fabricated in cylindrical build volumes of various diameters via tomography-based additive manufacturing.

Measuring a small refractive index can be performed with advanced optical techniques such as interferometry or Schlieren imaging.

Though interferometric imaging is the most sensitive of the aforementioned techniques, it is not easy to adapt it to the measurement of tomographic photopolymerization process, since it requires a complex optical setup, a clean coherent light source as well as a compensation path to ensure accurate measurements (Srivastava, A., Muralidhar, K. & Panigrahi, P. K. Comparison of interferometry, schlieren and shadowgraph for visualizing convection around a KDP crystal. Journal of Crystal Growth 267, 348-361 (2004)). In tomography-based additive manufacturing, the objects are produced in a rotating cylindrical glass vial, the build volume. To perform interferometric measurements, it is necessary to equalize the measurement path and the blank compensation path. However, compensating for the cylindrical aberration induced by the build volume demands additional optics or placing the build volume in an immersion bath filled with a refractive-index matching liquid. A liquid compensation path is not practical within an industrial-grade apparatus, as the liquid could evaporate or spill on the inner sensitive parts of the machine. Furthermore, interferometric measurements are affected by their high sensitivity to thermal gradient, like the ones generated during the exothermic photopolymerization onset of objects in tomography-based additive manufacturing.

Schlieren imaging, in which refractive-index gradients are measured, is not practically adapted to monitoring tomography-based additive manufacturing. Schlieren imaging requires optically filtering the light field unrefracted by the density gradient. In the same way as interferometric imaging, the cylindrical aberration induced by the build volume would require an optical compensation to correctly filter out the unrefracted rays to perform Schlieren imaging. Such a compensation cannot accommodate different build volume diameters or requires to use an immersion bath filled with a refractive-index matching. Thus, Schlieren imaging is not straightforwardly applicable within an industrial-grade tomographic printer.

In detail, the present invention is related to an apparatus used for monitoring and measuring tomographic additive manufacturing of a three-dimensional article.

According to a first embodiment of the present invention, monitoring is performed using a shadowgraphy method.

In detail, the method according to the first embodiment for obtaining a set of corrected projection patterns 9 in a volumetric back-projection printer 1, the method comprising the steps of:
measuring two-dimensional projections of an object 5 being formed by volumetric printing with an imaging system 6, 7, 8 disposed around a container 3 in which the object 5 is being formed;
forming a three-dimensional image from said two dimensional measured projections;
extracting a difference between the desired 3D object and the object 5 measured with the imaging system 6, 7, 8;
generating a new set of projection patterns 9 by reverse tomographic back-projection.

Said object to be formed is a three-dimensional object/article.

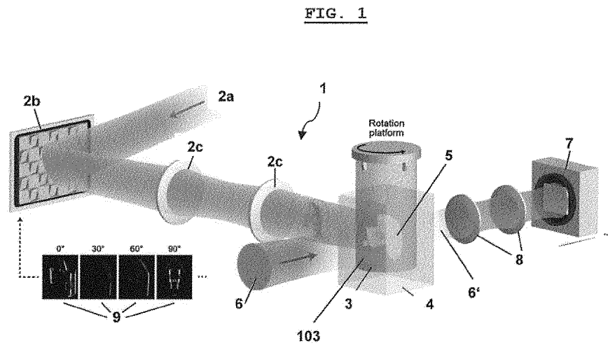

FIG. 1 shows a schematic illustration of an embodiment of a volumetric back-projection printer 1 according to the first embodiment of the present invention. An imaging system 2 is composed of a collimated illuminating light beam 2a, a DLP modulator 2b and a system of lenses 2c. Said collimated illuminating light beam 2a is incident (i.e. projecting two-dimensional light-patterns) on a rotatable resin container 3 (a transparent vessel that comprises photoresponsive material 103), that is provided within an index-matching liquid bath 4, and in which an object 5 is formed from said photoresponsive material 103 by volumetric printing, such as via tomographic back-projections or by multi-beam (with one or more wavelengths for resin solidification). Specifically, the resin container 3 and the photoresponsive material 103 provided therein are set into rotation while concurrently illuminated with the two-dimensional light patterns provided by said illuminating light beam 2a. The cumulative effect of illuminating the photoresponsive material from multiple angles is to locally photopolymerize the photoresponsive material, thereby creating an object (three-dimensional article) 5. Thus, the object 5 is formed by illumination with the beam 2a. The beam 2a is modulated by projection patterns in the DLP modulator 2b. Such a system is known, for example from WO 2019/043529 A1 or US 2018/0326666 A1.

An additional imaging system 6, 7, 8 for monitoring comprises the measuring beam 6, the camera 7 and the lens system 8. The forming object 5 is illuminated with said beam 6 and imaged onto the camera 7 via the lens system 8 of appropriate magnification and aberration correction. The plane of best focus can be chosen to be in the middle of the container 3, but is not limited to. The measuring beam 6 may be expanded by lenses (not shown in FIG. 1) to project a collimated light beam onto said photoresponsive material 103 and formed object (three-dimensional article) 5. The refractive index difference between the formed object (three-dimensional article) 5 and the photoresponsive material 103 in the container 5 produces a refracted light beam 6′ from the measuring beam 6.

For each rotation angle of the container 3, an image is recorded on the camera 7. The wavelength of the measuring beam 6 is different than the wavelength of the beam 2a used to initiate polymerization of the object 5, such that it does not cause polymerization of the photoresponsive material 103 in the container 3. In FIG. 1, the additional imaging system 6, 7, 8 is shown making a 90 degree angle to the illumination beam 2a that creates the object 5. It is shown here a 90° angle for convenience, but any angle between the projected patterns (the beam 2a) creating the object 5 and the collimated measuring beam 6 can be appropriate. According to the first embodiment, there is no particular limitation as to the kind of measuring beam 6, camera 7 and lens system 8 except those discussed above.

According to a variant of the system of the first embodiment shown in FIG. 1, shadowgraphs can also be performed without an index-matching liquid immersion bath 4. This is an advantage over interferometric imaging and Schlieren imaging, where an index-matching liquid immersion bath 4 is mandatory. Immersing the transparent container 3 in a bath of index-matching liquid 4 is not applicable to an industrial-scale apparatus. The index-matching liquid will tend to evaporate within the sealed machine, which may eventually damage neighboring electronical devices such as the rotation platform to which the transparent vessel 3 is attached.

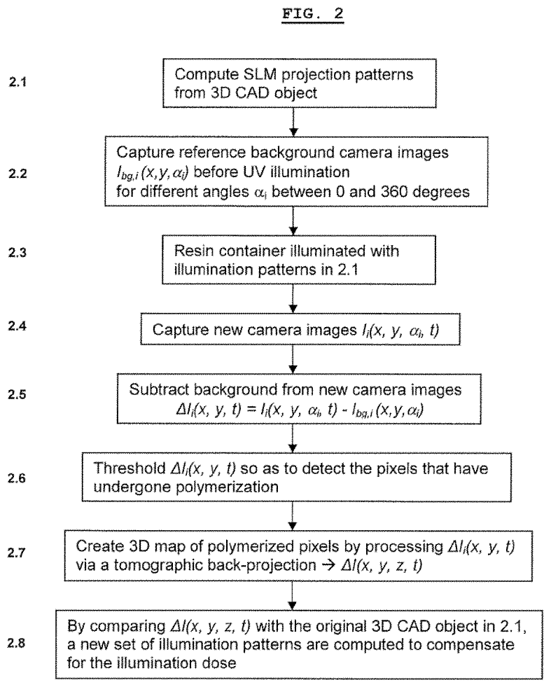

In FIG. 2, a flow diagram explains an embodiment of the invention of computing the projection patterns based on the 3D measurement of the solidification of the object being formed.

First, in step 2.1 a three-dimensional computer aided design of the object 5 is processed to generate a set of projection patterns 9 in the tomographic back-projection volumetric printer 1. This step can be adapted to any type of volumetric printer such as, but not limited to multi-beam volumetric printers.

In step 2.2, a set of reference images (background images) I_{b,g,i} (x,y,aᵢ) are recorded upon rotating the build volume before starting the actual exposure, in step 2.3, with the light wavelength 2a sensitive to the resin.

In step 2.4, the camera 7 of the imaging system 6, 7, 8 records intensity images Iᵢ (x,y,aᵢ,t) of the build volume in synchronization with the rotation of the resin container 3. The intensity imaging system 6, 7, 8 is used with any resin material that scatters light upon solidification in such a way that the solidified area shows up as dark in the intensity image. If the object 5 being formed (i.e. solidified) scatters light weakly so as to remain transparent, a phase imaging system can be substituted to the intensity imaging system 6, 7, 8 illustrated in FIG. 1. State of the art phase imaging systems include, but are not limited to, holographic, shearing interferometry or via transport of intensity measurement.

The build volume is illuminated from the back (transmission imaging) by an expanded and collimated laser beam 6 with a wavelength different than the wavelength of the beam 2a used for polymerizing the resin.

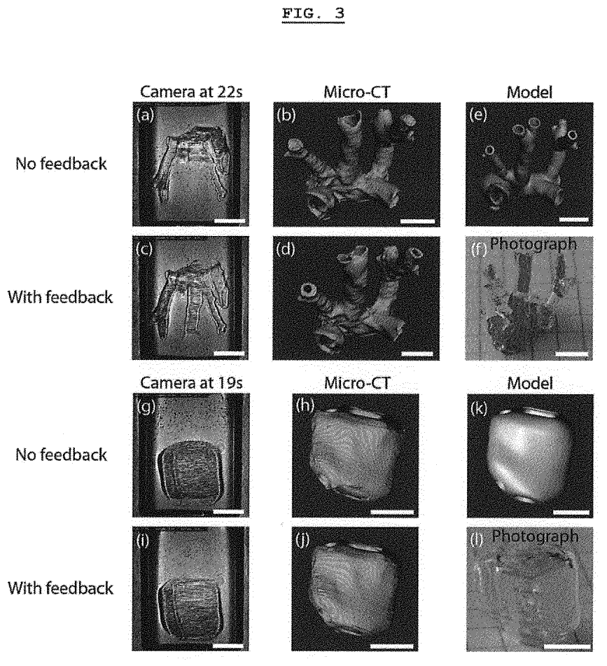

Then, a new set of images are recorded for each angle, filtered and down-sampled to reduce noise and speed up processing respectively. As seen in FIGS. 3(a,c,g,i), the resin appears darker when it solidifies (due to refraction and scattering).

Then, in step 2.5 the difference ΔIᵢ (x,y,t)=Iᵢ (x,y,aᵢ,t)−I_{b,g,i} (x,y,aᵢ)) between the new set of images and the set of background images is computed on each subsequent turn.

A threshold ΔIᵢ (x,y,t) is then used in step 2.6 to detect which parts of the volume became solid (i.e. scattered light) at which time. Spatially, this information is still two-dimensional at this point because it is derived from 2D transmission images of the entire build volume.

In order to build a three-dimensional map of the time needed for solidification, in step 2.7 the said difference images are back-projected using the tomographic algorithm to obtain the time values into a 3D grid. When a transmission image at a particular angle and time showed ‘solid pixels’ (as measured by the thresholding procedure), the time of solidification was recorded in the 3D volume in a line corresponding to these pixels and oriented along the direction of projection. If a later transmission image from any other angle shows no solidification or a transition to solid state at a later time for the same group of pixels in 3D, then the recorded solidification time was increased for those pixels. The resulting 3D volume of ‘solidification times’ directly gives the required intensity correction for the next print. Indeed, the dose D is related to intensity I and time t as D=I·t. If a given part of the object takes a longer time t to solidify, the intensity I in this part simply needs to be increased proportionally to make it solid at the same time as the rest of the model. After this 3D intensity adjustment, in step 2.8 corrected Radon projections (corrected projection patterns) are calculated from the corrected model of the object using the same procedure as described before.

Thus, according to the first embodiment the new set of projection patterns 9 is preferably generated by the following steps:
Computing SLM (Spatial light modulator) projection patterns from an original 3D digital object, preferably a 3D CAD object;
Capturing reference background camera images with the camera 7 for different angles of rotation of the resin container 3;
Illuminating the resin container 3 with the beam 2a using the SLM projection patterns computed from the 3D digital object, preferably 3D CAD object;
Capturing images of the object 5 being formed with the camera 7;
Subtracting the reference background camera images from the images of the object 5 being formed;
Detecting parts of the resin container 3 that became solid using a threshold;
Creating a 3D map of said solid parts by a tomographic back-projection method;
Generating the new set of projection patterns 9 by comparing the created 3D map with the original 3D digital object, preferably 3D CAD object.

Said new set of projection patterns 9 is used for adjusting the illumination dose of the beam 2a.

FIG. 3 shows images of printed objects as well as a 2D intensity image from the measurement system at a particular angle when feedback according to the present invention and no feedback has been used. It shows that feedback according to the present invention improved the printing accuracy. Clearly, in FIG. 3(a), the central artery is not formed at the same time as the other part of the object 5. This yields an incomplete central artery in the fabricated object 5 in FIG. 3(b), as compared to the model shown in FIG. 3€. Whereas, when the corrected set of projection patterns 9 from the feedback system is used, the central artery is correctly printed (FIGS. 3(c) and (d)). In FIG. 3(f) the photograph of the pulmonary artery printed with the feedback corrected patterns 9 shows the structure filled with a red dye to better visualize the channels. FIG. 3(l) shows a photograph of the hearing aid model printed using the feedback corrected patterns. Scale bars are 5 mm.

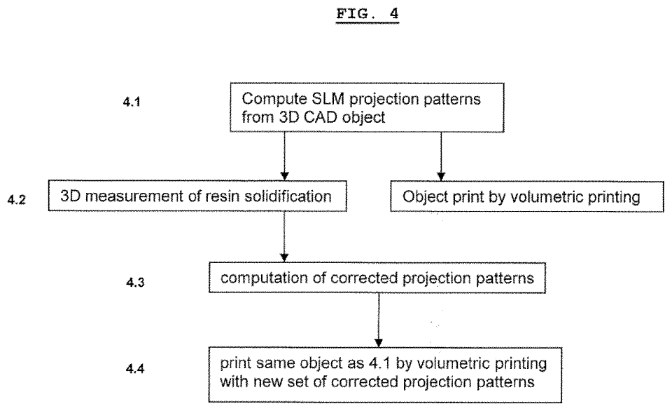

FIG. 4 shows the flow diagram used for calculating the corrected set of projection patterns 9 which is then subsequently used in a new print. Essentially, the first print is a sacrificial print that is used to obtain the new set of patterns. If the material has the same properties, it is expected that the new print will be corrected.

Thus, according to this variant of the first embodiment, the first print made by illuminating the resin container 3 with the beam 2a using the SLM projection patterns computed from the 3D digital object, preferably 3D CAD object is a sacrificial print that is used to obtain the new set of projection patterns 9.

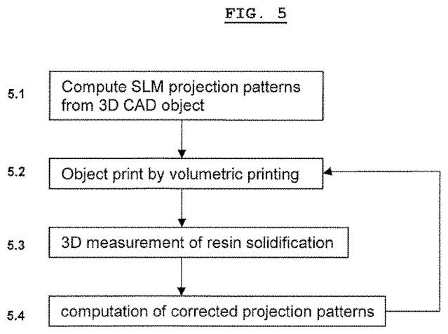

In the case when a sacrificial print cannot be done or to further increase the fidelity of the print, a real-time correction feedback system can be implemented (FIG. 5).

FIG. 5 shows the flow diagram used for calculating the corrected set of projection pattern which is used in a real time closed-loop system to the pattern projection system (Spatial light modulator: SLM). Here the computation has to be fast in order to implement it in real time. Thus, according to this variant of the first embodiment, a real-time correction feedback system is implemented instead of performing a sacrificial print.

Thus, according to the first embodiment, the present invention is related to a method of printing an object 5 in a volumetric back-projection printer 1, the method comprising the steps of
Obtaining a set of corrected projection patterns 9 with the method described above;
Printing the object using the set of corrected projection patterns 9.

According to the first embodiment of the present invention, a system for obtaining a set of corrected projection patterns 9 and for printing an object 5 in a volumetric back-projection printer 1, comprises
A resin container 3 for providing a resin to be polymerized, wherein said resin container 3 is rotatable;
A unit for providing a light beam 2a to be guided into the resin container 3, said unit comprising a DLP modulator 2b and at least one lens 2c;
An imaging system 6, 7, 8 disposed around the resin container 3 for illuminating the resin container 3 with a beam 6 of a wavelength different of the wavelength of the beam 2a, wherein said imaging system 6, 7, 8 comprises a camera 7 and at least one lens 8; and
A processing unit for computing a new set of projection patterns 9.

Said resin container 3 may be arranged in an index matching liquid bath 4; however, this is not mandatory.

Preferably, said imaging system 6, 7, 8 and said unit for providing a light beam 2a to be guided into the resin container 3 are arranged such that an angle is formed between the beam 6 and the beam 2a when entering the resin container 3. More preferably, said angle is 90°.

According to a second embodiment of the present invention, the apparatus comprises a device for performing a structured illumination for monitoring, for example, but not limited to, an LCD display or a Digital Light Processor (DLP), a camera objective with optionally an adjustable numerical aperture diaphragm, and a camera.

For clarification, the term structured illumination used in this invention has the same meaning as in the state of the art. It means any two dimensional spatially varying light intensity.

As shown above in FIG. 3, with the method according to the first embodiment of the present invention, already a clear advantage is achieved as compared to a tomographic additive manufacturing method where no such monitoring (feedback) is applied.

However, the method according to the first embodiment of the present invention has drawbacks in determining the edges of manufactured three-dimensional articles when the refractive index difference between the unpolymerized photoresponsive material and the manufactured three-dimensional article is too small to induce significant refraction, e.g. below 0.01.

With the method according to the second embodiment of the present invention, an even more sensitive imaging apparatus to monitor tomographic additive manufacturing is provided.

According to the second embodiment, the present invention is related to a method of increasing the sensitivity of the structured illumination monitoring of tomographic additive manufacturing comprising the steps of:
Providing in a transparent cylindrical container of an apparatus for tomographic additive manufacturing, a photoresponsive material,
Generating from a first light source of said apparatus two-dimensional light-patterns based on computed tomographic projections of said three-dimensional article,
Generating from a second light source, to which said photoresponsive material is not sensitive, a structured illumination,
Projecting said structured illumination onto said transparent cylindrical container,
Setting in rotation said transparent cylindrical container,
Concurrently imaging and recording the content of said rotating transparent cylindrical container from multiple angles with a camera equipped with a camera lens,
Once said transparent cylindrical container has performed at least one complete rotation, concurrently performing a differential overlay of an image recorded at an angle by the image recorded from said angle during said previous rotation, thereby increasing the sensitivity of imaging of said rotating transparent cylindrical container,
Concurrently projecting said two-dimensional patterns into said photoresponsive material and defining a three-dimensional dose distribution,
Evaluate from said processed differential images if the three-dimensional article (object 5) has already been completely manufactured,
If the three-dimensional article (object 5) is completely manufactured, stop projecting the two-dimensional light patterns, thereby creating said article (object 5),
If the three-dimensional article (object 5) is not completely manufactured, wait for the three-dimensional article to be manufactured and keep projecting the two-dimensional light patterns into the photoresponsive material 103 (i.e. extend the tomographic additive manufacturing process).

For clarification, the term differential overlay used in this invention has the same meaning as in the state of the art. It means computing and displaying an overlay of a first image from which is subtracted a second image with a scaling factor applied on all the pixels of the second image.

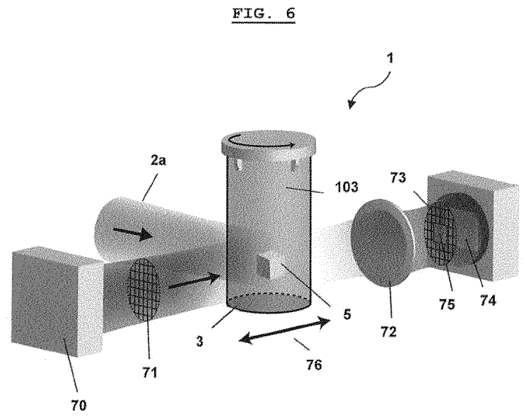

FIG. 6 shows a preferred variant of the second embodiment of an apparatus of the present invention. A tomographic additive manufacturing apparatus 1 is projecting two-dimensional light-patterns with the beam 2a into a photoresponsive material 103 that is contained in a transparent container 3. The transparent container 3 and the photoresponsive material 103 are set into rotation by a rotation platform while being concurrently illuminated with the two-dimensional light patterns by the beam 2a. The cumulative effect of illuminating the photoresponsive material from multiple angles is to locally photopolymerize the photoresponsive material, thereby creating an object (three-dimensional article) 5. A light source of one or more colors 70, for example but not limited to an LCD display, emits a structured illumination 71, for instance but not limited to a grid, towards the photoresponsive material 103 and the object (three-dimensional article) 5 being manufactured.

In a preferred variant of the second embodiment, said photoresponsive material is not sensitive to the wavelength of said structured illumination.

In a preferred variant of the second embodiment, a camera lens 72 relays the image 73 of the structured illumination refracted by the photoresponsive material 103 and the object (three-dimensional article) 5 onto a camera sensor 74. The focus of the part of said structured illumination that propagated through said object (three-dimensional article) 5 is shifted because of the higher refractive index of said object (three-dimensional article) 5 with respect to said photoresponsive material 103. The focal shift of said part of the structured illumination creates an image 75 of said object (three-dimensional article) 5.

In a further preferred variant of the second embodiment, the numerical aperture of the camera lens 72 can be adjusted, which in turn adjust the depth of focus 76 of the camera 74.

In a further preferred variant of the second embodiment, both the object (three-dimensional article) 5 and the source 70 of the structured illumination 71 are at focus on the camera sensor 74.

In a further preferred variant of the second embodiment, the colors of the structured illumination 71 are displayed sequentially and captured by camera sensor 74 at a speed faster than the two-dimensional light patterns provided by the beam 2a. An enhanced contrast of the object created may be obtained by subtraction of said colored structured images because of the slight axial and lateral shift due to color.

In a further preferred variant of the second embodiment, an optical filter is placed between said camera lens 72 and said transparent vessel (container 3) to filter out the wavelength of said two-dimensional light patterns but still transmit the wavelength of said structured illumination.

In a further preferred variant of the second embodiment, a controller is used to synchronize the image acquisition by the camera 74 with the rotation of the photoresponsive material 103 and transparent vessel (container 3).

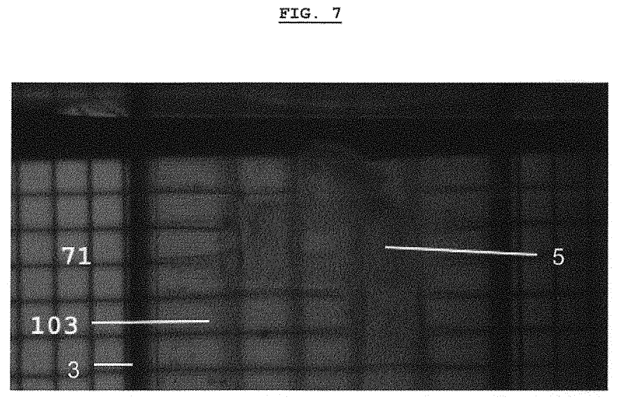

FIG. 7 shows an experimental measurement performed within a tomographic additive manufacturing apparatus using a similar variant as the second embodiment illustrated in FIG. 6. A liquid-crystal display projects a structured illumination 71 onto a photoresponsive material 103 contained in a cylindrical transparent vessel (corresponding to container 3). A three-dimensional article (object 5) is produced through tomographic additive manufacturing. The refractive index difference between said three-dimensional article and said photoresponsive material shifts the image of said structured illumination, thereby allowing monitoring and measuring the manufacturing of said three-dimensional article.

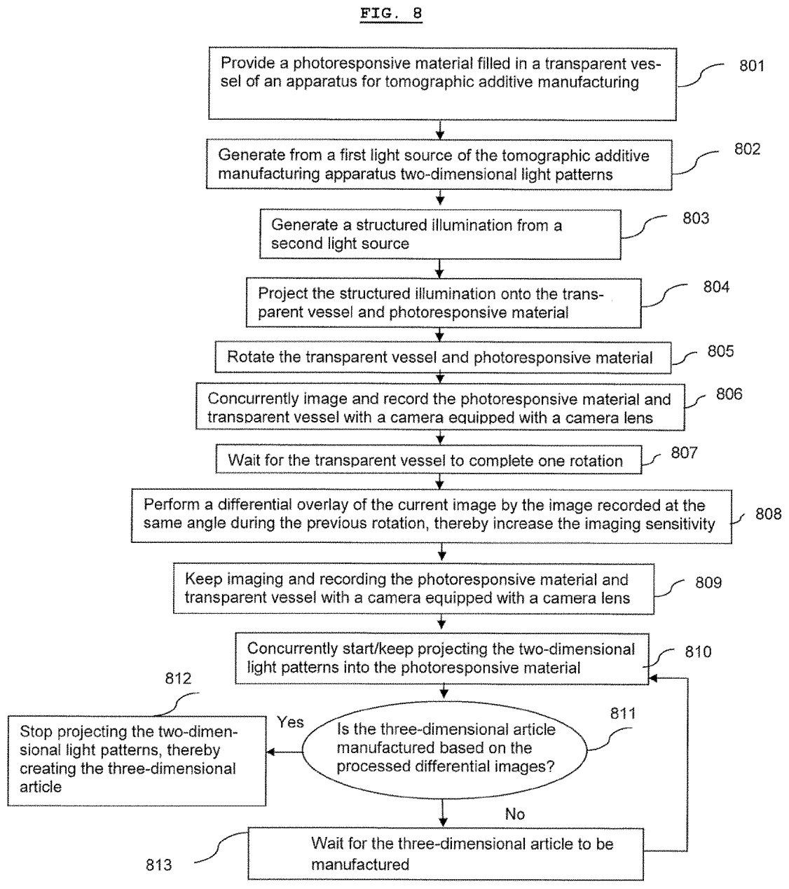

The flowchart of FIG. 8 further describes a method of the present invention to increase the sensitivity of the structured-illumination monitoring of tomographic additive manufacturing, using the apparatus according to the second embodiment described above. The method comprises the steps of:
Providing in a transparent vessel (container 3) of an apparatus for tomographic additive manufacturing, a photoresponsive material 103 (step 801).
Generating from a first light source of said apparatus two-dimensional light patterns by a beam 2a, based on computed tomographic projections of said three-dimensional article (step 802).
Generating from a second light source 70, whose wavelength does not alter the phase of said photoresponsive material 103, a structured illumination 71, as described above (step 803).
Projecting said structured illumination 71 onto said transparent vessel (container 3) and photoresponsive material 103 (step 804).
Setting in rotation said transparent vessel (container 3) and photoresponsive material 103 (step 805).
Concurrently imaging and recording the structurally-illuminated content of said rotating transparent vessel (container 3) from multiple angles with a camera 74 equipped with a camera lens 72 (step 806).
Wait for the transparent vessel (container 3) to complete one rotation (step 807).
Perform a differential overlay of an image recorded at an angle by the image recorded from said angle during said previous rotation, thereby increasing the sensitivity of said structured-illumination imaging of said rotating transparent container (container 3) and (step 808).
Keep imaging and recording the content of said rotating transparent vessel (container 3) from multiple angles with a camera 74 equipped with a camera lens 72 (step 809).
Concurrently start projecting said two-dimensional light patterns into said photoresponsive material 103 and define a three-dimensional dose distribution, thereby creating a distribution of alterations in said material, thereby creating said article (object 5) (step 810).
Evaluate from said processed differential images if the three-dimensional article (object 5) has already been completely manufactured (step 811);
If the three-dimensional article (object 5) is completely manufactured, stop projecting the two-dimensional light patterns, thereby creating said article (object 5) (step 812);
If the three-dimensional article (object 5) is not completely manufactured, wait for the three-dimensional article to be manufactured (step 813) and keep projecting the two-dimensional light patterns into the photoresponsive material 103 (step 810) (i.e. extend the tomographic additive manufacturing process).

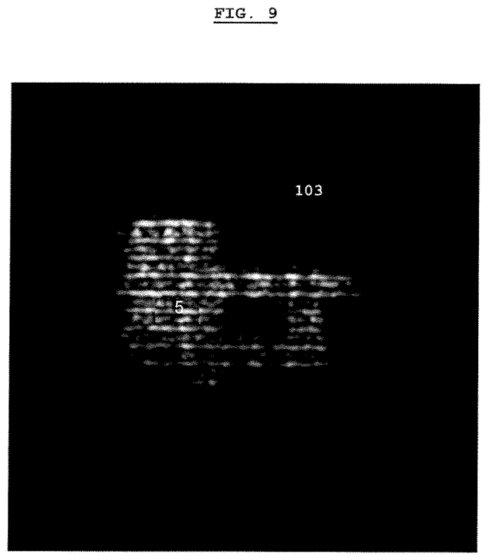

FIG. 9 shows an experimental measurement performed within a tomographic additive manufacturing apparatus according to the second embodiment using the increased imaging sensitivity method described in the flowchart of FIG. 8. The three-dimensional article (object 5) manufactured using a tomographic additive manufacturing apparatus according to the second embodiment is imaged within the photoresponsive material 103.

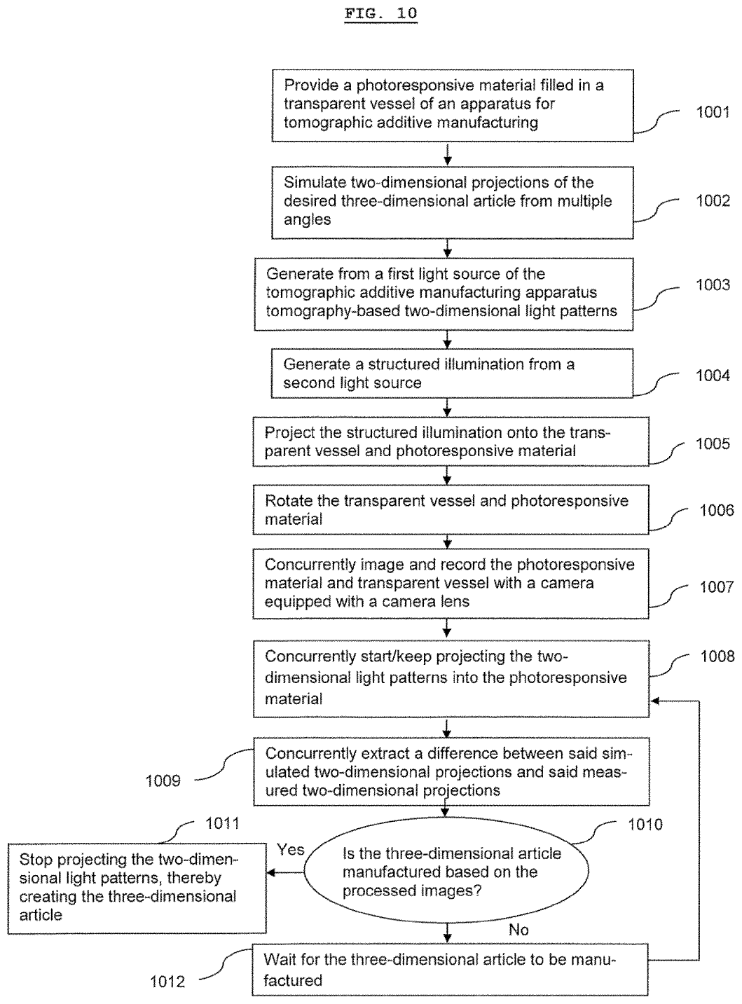

The flowchart of FIG. 10 further describes a method of the present invention to automatically stop a tomographic additive manufacturing process using the structured-illumination imaging method and apparatus according to the second embodiment of the present invention. The method comprises the steps of:
Providing in a transparent vessel (container 3) of an apparatus for tomographic additive manufacturing, a photoresponsive material 103 (step 1001);
Simulating two-dimensional projections of a desired three-dimensional article from multiple angles (step 1002);
Generating from a first light source of said apparatus said tomography-based two-dimensional light patterns by a beam 2a (step 1003);
Generating from a second light source 70, whose wavelength does not alter the phase of said photoresponsive material 103, a structured illumination 71, as described above (step 1004);
Projecting said structured illumination 71 onto said transparent vessel (container 3) and photoresponsive material 103 (step 1005);
Setting in rotation said transparent vessel (container 3) and photoresponsive material 103 (step 1006);
Concurrently imaging and recording the structurally-illuminated content of said rotating transparent vessel (container 3) from multiple angles with a camera 74 equipped with a camera lens 72 (step 1007);
Concurrently project said two-dimensional light patterns into said photoresponsive material 103 and define a three-dimensional dose distribution, thereby creating a distribution of alterations in said material (step 1008);
Concurrently extracting a difference between said simulated two-dimensional projections of the desired article and said two-dimensional projections of the article (object 5) measured with the structured-illumination imaging system (70, 71, 72, 74) (step 1009);
Evaluate from said difference determined in step 1009 if the three-dimensional article (object 5) has already been completely manufactured (step 1010);
If the three-dimensional article (object 5) is completely manufactured, stop projecting the two-dimensional light patterns, thereby creating said article (object 5) (step 1011);
If the three-dimensional article (object 5) is not completely manufactured, wait for the three-dimensional article to be manufactured (step 1012) and keep projecting the two-dimensional light patterns into the photoresponsive material 103 (step 1008).

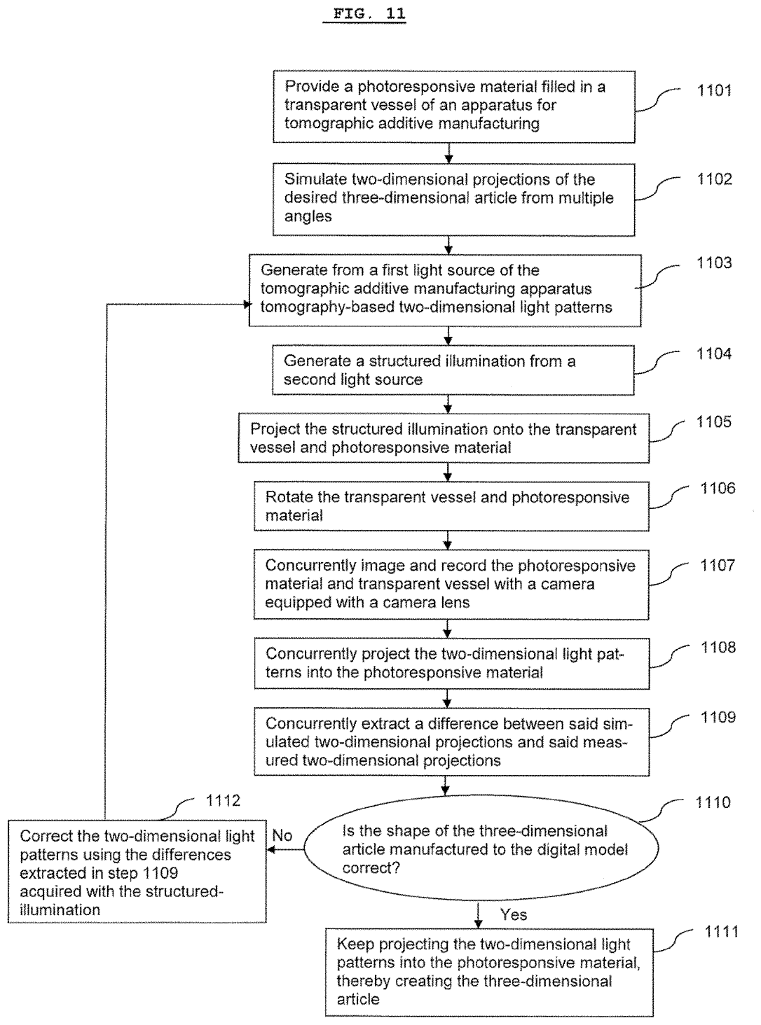

The flowchart of FIG. 11 further describes a method of the present invention to correct the two-dimensional light patterns 102 of a tomographic additive manufacturing process using the structured-illumination imaging method and apparatus according to the second embodiment of the present invention. The method comprises the steps of:
Providing in a transparent vessel (container 3) of an apparatus for tomographic additive manufacturing, a photoresponsive material 103 (step 1101);
Simulating two-dimensional projections of the desired three-dimensional article from multiple angles (step 1102);
Generating from a first light source of said apparatus tomography-based two-dimensional light patterns by a beam 2a (step 1103);
Generating from a second light source 70, whose wavelength does not alter the phase of said photoresponsive material 103, a structured illumination 71, as described above (step 1104);
Projecting said structured illumination 71 onto said transparent vessel (container 3) and photoresponsive material 103 (step 1105);
Setting in rotation said transparent vessel (container 3) and photoresponsive material 103 (step 1106);
Concurrently imaging and recording the structurally-illuminated content of said rotating transparent vessel (container 3) from multiple angles with a camera 74 equipped with a camera lens 72 (step 1107);
Concurrently project said two-dimensional light patterns into said photoresponsive material 103, and define a three-dimensional dose distribution, thereby creating a distribution of alterations in said material (step 1108);
Concurrently extracting a difference between said simulated two-dimensional projections of the desired article and said two-dimensional projections of the article (object 5) measured with the structured-illumination imaging system (70, 71, 72, 74) (step 1109);
Based on the differences extracted in step 1109, concurrently evaluate if the shape of the three-dimensional article (object 5) being manufactured, as compared to the digital model represented by the two-dimensional projections of the three-dimensional desired object, is correct (step 1110);
If the shape of the three-dimensional article (object 5) being manufactured, as compared to the digital model, is correct, keep projecting the two-dimensional light patterns, thereby creating said article (step 1111);
If the shape of the three-dimensional article (object 5) being manufactured, as compared to the digital model, is not correct, correct the two-dimensional light patterns using the images acquired with the structured-illumination imaging and go back to step 1102 (step 1112).

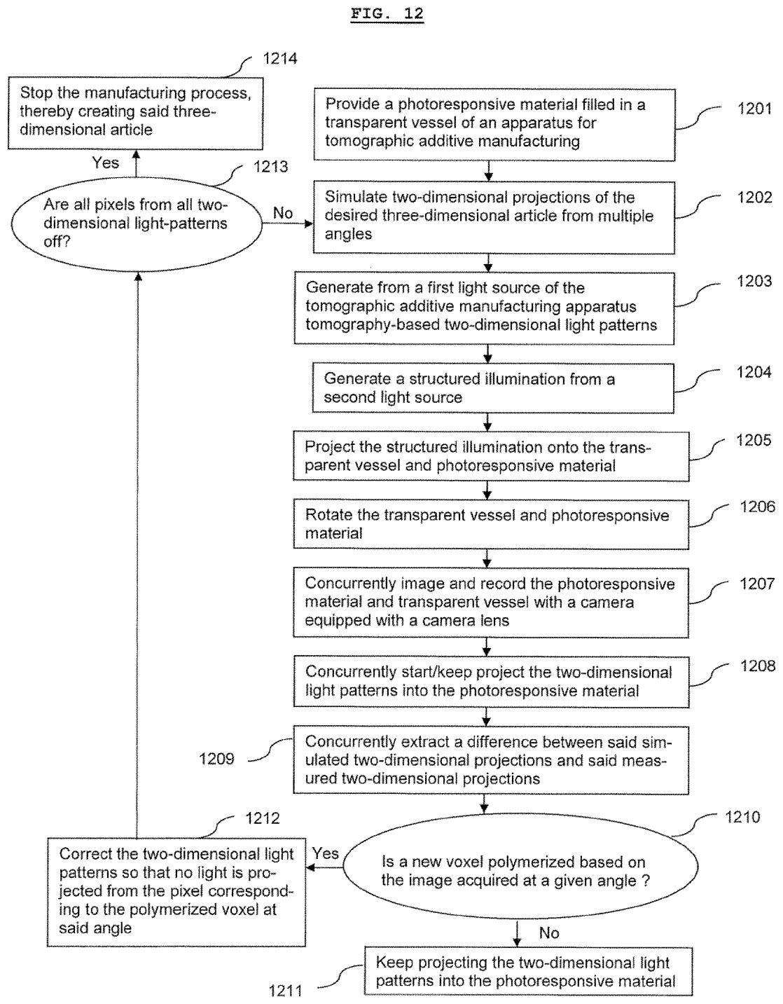

The flowchart of FIG. 12 further describes a variant of the second embodiment, in particular a method of the present invention to automatically and locally stop the exposure of a local volume that has been photopolymerized using the structured-illumination imaging method and apparatus according to the second embodiment of the present invention. The method comprises the steps of:
Providing in a transparent vessel (container 3) of an apparatus for tomographic additive manufacturing, a photoresponsive material 103 (step 1201).
Simulating two-dimensional projections of the desired three-dimensional article from multiple angles (step 1202).
Generating from a first light source of said apparatus tomography-based two-dimensional light patterns by a beam 2a (step 1203).
Generating from a second light source 70, whose wavelength does not alter the phase of said photoresponsive material 103, a structured illumination 71 (step 1204).
Projecting said structured illumination 71 onto said transparent vessel (container 3) and photoresponsive material 103 (step 1205).
Setting in rotation said transparent vessel (container 3) and photoresponsive material 103 (step 1206).
Concurrently imaging and recording the structurally-illuminated content of said rotating transparent vessel (container 3) from multiple angles with a camera 74 equipped with a camera lens 72 (step 1207).
Concurrently project said two-dimensional light patterns into said photoresponsive material 103, and define a three-dimensional dose distribution, thereby creating a distribution of alterations in said material (step 1208).
Concurrently extracting a difference between said simulated two-dimensional projections of the desired article and said two-dimensional projections of the article (object 5) measured with the structured-illumination imaging system (70, 71, 72, 74) (step 1209).
In this variant, it is not the shape of the manufactured three-dimensional article that is compared to a digital model. Here, based on the differences extracted in step 1209 from an angle, it is concurrently evaluated if a new voxel or several new voxels have been polymerized (step 1210).
If no new polymerized voxel is detected, keep projecting the two-dimensional light patterns into the photoresponsive material and go back to step 1209 (step 1211).
If a new voxel or new voxels have polymerized, concurrently correct the two-dimensional light patterns so that light is no longer projected from the pixel or pixels corresponding to the polymerized voxels at said angle (step 1212).
Concurrently check if all pixels from all two-dimensional light patterns are no longer projecting light, that is to say, if they are all off (step 1213).
If light is still projected in said corrected two-dimensional light patterns, go to step 1203.
If all pixels from all two-dimensional light patterns are off, stop the manufacturing process, thereby creating said three-dimensional article (step 1214).

According to a third embodiment of the present invention, an accelerated correction procedure for the projected patterns is provided. According to this embodiment, each captured image of the object being formed is processed to detect which pixels of the image correspond to regions of the photoresponsive material that are already cured. This processing can be done for example by comparing each image to a reference image (background image) taken at the same angle before the start of exposure, and then applying a threshold to detect pixels that changed (pixels that “cured”), as explained in more detail for a previous embodiment. Other examples of processing include edge-detection filters or artificial intelligence-based image recognition. The background image and the captured image of the object being formed can be recorded with an imaging system like the imaging system 6,7,8 used in the first embodiment. However, the third embodiment is not limited with respect to the imaging system.

The processing yields a map of pixels that correspond to parts of the object being printed which are already cured, as seen from a specific rotation angle (i.e. the angle at which the camera image was recorded). Using this pixel map, the corresponding pixels at the corresponding angles in the set of projected light patterns are disabled (set to 0) or attenuated (set to a significantly lower value) in order to prevent over-curing at this location.

Thus, with this accelerated correction procedure, the camera images can be processed without knowledge of the shape of object, yet it still yields the desired corrections for the light patterns. More specifically, in this embodiment the camera images are neither compared to the two-dimensional projections nor to the three-dimensional model of the object, yet the method still produces corrected light patterns that avoid overexposure of parts of the object that are already cured during any point of the printing procedure. Because of the reduced amount of computations, this correction procedure can more easily be implemented with a high processing speed and in real-time.

It is understood that a camera image captured at a given angle can be used to correct one or multiple light projections at similar angles, depending on whether the rate of acquisition of the camera is equal to or different from the rate of projection of the light patterns. It is also understood that multiple camera images can be acquired at the same angle, or similar angles, in order to observe how the photoresponsive material changes over time as seen from this particular angle.

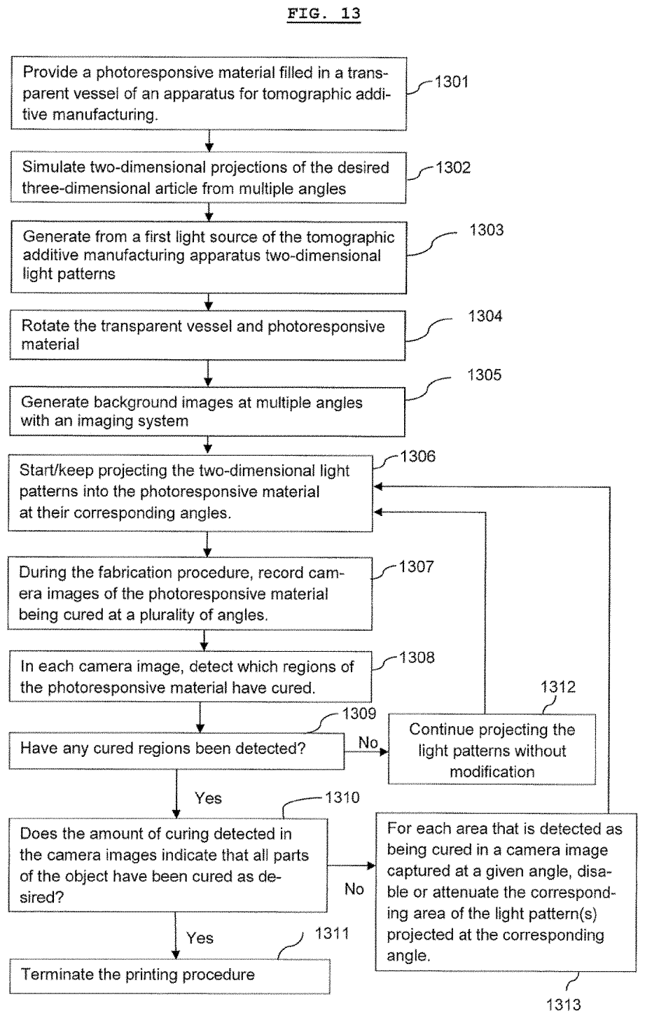

Thus, according to the third embodiment the method preferably comprises the following steps as illustrated in the flowchart of FIG. 13:
Providing a photoresponsive material in a transparent vessel (step 1301);
Computing (simulating) the two-dimensional light patterns required for tomographic additive manufacturing from an original 3D model of the object, from multiple angles (step 1302);
Generating from a first light source of said apparatus two-dimensional light patterns by a beam 2a (step 1303);
Setting in rotation said transparent vessel (container 3) and photoresponsive material 103 (step 1304);
Generate background images (reference images) of the transparent vessel (container 3) and photoresponsive material 103 at multiple angles with an imaging system, such as the imaging system 6,7,8 (step 1305);
Projecting said two-dimensional light patterns into the photoresponsive material (step 1306);
Concurrently record images of the photoresponsive material from a plurality of angles as it is being cured (step 1307);
Process the camera images to detect which areas of the photoresponsive material have cured, by applying a threshold (step 1308);
Check if any cured region was detected (step 1309);
If there are no cured regions, continue projecting the light patterns without modification (step 1312).
If there are cured regions, check if the amount of curing is sufficient to stop the printing procedure (step 1310).
If the amount of curing is sufficient, terminate the printing procedure (step 1311).
Otherwise, for each camera image where cured regions were detected, disable or attenuate the corresponding regions in the light patterns at the corresponding angles (step 1313) and continue the fabrication procedure.

The present invention is furthermore related to a system as already described above. In detail, the present invention is related to a system for obtaining a set of corrected projection patterns (9) and for printing an object (5) in a volumetric back-projection printer (1), comprising
A resin container (3) for providing a resin 103 to be polymerized, wherein said resin container (3) is rotatable;
A unit for providing a light beam (2a) to be guided into the resin container (3), said unit comprising a DLP modulator (2b) and preferably at least one lens (2c);
An imaging system (6, 7, 8; 70, 71, 72, 74) disposed around the resin container (3), wherein said imaging system (6, 7, 8) comprises a camera (7; 74) and at least one lens (8; 72); and
A processing unit for computing a new set of projection patterns (9).

1.-17. (canceled)

18. A method for monitoring the generation of a three-dimensional object being formed in a tomographic additive manufacturing system from simulated tomographic two-dimensional back-projections of a desired 3D article, the method comprising the steps of:
illuminating a container comprising a photoresponsive material with a light beam of two-dimensional light patterns generated from said two-dimensional back-projections at multiple angles, so as to form the object in the container;
capturing images of said object being formed by volumetric printing with an imaging system disposed around the container in which the object is being formed;
determining from said images the shape or extent to which the object has been formed;
i.—based on the determination, either generate a new set of two-dimensional light patterns for tomographic printing;
ii. correct in real-time the two-dimensional light patterns used for tomographic printing;
iii. automatically extend said tomographic additive manufacturing process; or
iv. automatically stop said tomographic additive manufacturing process, thereby finishing the formation of said object.

19. The method according to claim 18, wherein two-dimensional projections (9) of said desired 3D article are computed from an original 3D digital object.

20. The method according to claim 18, wherein the images of said object are captured by said imaging system concurrently with illuminating said container with the two-dimensional light patterns.

21. The method according to claim 18, wherein it further comprises capturing reference background images at multiple angles of the container comprising the photoresponsive material before said container is illuminated with the two-dimensional light patterns, wherein in the step of determining from said images the shape or extent to which the object has been formed the reference background images are subtracted from the captured images of said object being formed, so as to detect parts of the resin container that became polymerized using a threshold.

22. The method according to claim 21, wherein from detected polymerized parts a 3D map is created by a tomographic back-projection method, and new set of projection patterns is generated by comparing the created 3D map with the original 3D digital object, wherein the new set of projection patterns is used either for printing the same object by restarting the method, using the first printed object as a sacrificial print, or for implementing a real-time correction feedback system.

23. The method according to claim 18, wherein from detected polymerized parts a map of the regions of the object is generated that have already been formed as seen from the angles at which each captured image and optionally background image was recorded, and
the method is stopped if it is detected that all parts of the object have been formed, or
the method is continued without modification of the two-dimensional light patterns if it is detected that no part of the object has been formed, or
the two-dimensional light projections used for tomographic printing are corrected in real-time such that corresponding regions at the corresponding angles are disabled or attenuated in the two-dimensional projections of light used to form the object.

24. The method according to claim 18, wherein the imaging system comprises a structured illumination for generating the captured images.

25. The method according to claim 24, wherein a difference is extracted between the captured images of the object being formed and the desired 3D article, said difference being used to generate the new set of projection patterns by reverse tomographic back-projection.

26. The method according to claim 25, wherein said extracted difference is used for determining whether the object has been completely manufactured or whether the shape of the object is correct, wherein the method is stopped if complete manufacturing of the object is determined, or illuminating the container with two-dimensional light patterns continues if the shape of the object is correct or no complete manufacturing of the article is determined.

27. The method according to claim 24, wherein each of said measurements of the two-dimensional projections of the object is obtained by performing a differential overlay of a first two-dimensional projection measured with said imaging system at an angle by a second two-dimensional projection previously measured with said imaging system from said same angle.

28. The method according to claim 18, wherein the beam is modulated by projection patterns in a DLP modulator.

29. The method according to claim 18, wherein the beam and either the structured illumination or a measuring beam enters the container at an angle of 90°.

30. A method of printing an object in a volumetric back-projection printer, the method comprising the steps of
obtaining a set of corrected or newly generated projection patterns with the method according to claim 18;
printing the object using the set of corrected projection patterns.

31. A system for performing a method according to claim 18, comprising
a resin container for providing a photoresponsive material to be polymerized, wherein said resin container is rotatable;
a unit for providing a light beam of two-dimensional light patterns to be guided into the resin container, said unit comprising a DLP modulator;
an imaging system disposed around the resin container, wherein said imaging system comprises either a) a measuring beam, a camera and a lens system, or b) a display unit emitting a structured light pattern, a lens system, an optional optical filter, and a camera sensor; and
a processing unit for determining from images captured by the imaging system a shape or extent to which an object has been formed when performing the method according to claim 18.

32. The system according to claim 31, wherein said display unit comprises a component selected from the group consisting of a liquid-crystal display illuminated by light with one or more colors, an organic light-emitting diode display with one or more colors, and a light-emitting diode display.

33. The system according to claim 31, wherein said resin container is arranged in an index matching liquid bath.

34. The system according to claim 31, wherein said imaging system and said unit for providing a light beam to be guided into the resin container are arranged such that an angle is formed between the beam or the structured illumination and the beam when entering the resin container.
